(19) United States
(12) Patent Application Publication
(10) Pub. No.: US 2026/0067649 A1
(43) Pub. Date: Mar. 5, 2026

(54) Sensing Service Capability Exposure Method and First Device

(71) Applicant: VIVO MOBILE COMMUNICATION CO., LTD., Dongguan (CN)

(72) Inventor: Weiwei Chong, Dongguan (CN)

(21) Appl. No.: 19/377,144

(22) Filed: Nov. 3, 2025

Related U.S. Application Data
(63) Continuation of application No. PCT/CN2024/090346, filed on Apr. 28, 2024.

(30) Foreign Application Priority Data
May 4, 2023 (CN) 202310497702.4

(51) Int. Cl. H04W 4/38; H04W 4/50; H04W 84/18

(52) U.S. Cl. CPC H04W 4/38; H04W 4/50; H04W 84/18

(57) ABSTRACT

A sensing service capability exposure method includes sending, by a first device, a first message to a second device, where the first message includes sensing service capability exposure information of the first device.

### CROSS-REFERENCE TO RELATED APPLICATIONS

This application is a Bypass Continuation Application of International Patent Application No. PCT/CN2024/090346 filed Apr. 28, 2024, and claims priority to Chinese Patent Application No. 202310497702.4 filed May 4, 2023, the disclosures of which are hereby incorporated by reference in their entireties.

### BACKGROUND OF THE INVENTION

### Field of the Invention

This application pertains to the field of communication technologies, and in particular, relates to a sensing service capability exposure method, and a first device.

### Description of Related Art

In a current architecture for communication and sensing service data capability exposure, a sensing function (SF) is added for a communication and sensing service. The SF is responsible for managing a communication and sensing service and processing communication and sensing data.

### SUMMARY OF THE INVENTION

According to a first aspect, a sensing service capability exposure method is provided and includes:
sending, by a first device, a first message to a second device, where the first message includes sensing service capability exposure information of the first device.

According to a second aspect, a sensing service capability exposure method is provided and includes:
receiving, by a second device, a first message sent by a first device, where the first message includes sensing service capability exposure information of the first device; and
storing, by the second device, the sensing service capability exposure information of the first device.

According to a third aspect, a sensing service capability exposure method is provided and includes:
sending, by a fourth device, a third message to a second device, where the third message is used to request information about a fifth device, and the fifth device supports exposure of sensing service data to the fourth device.

According to a fourth aspect, a sensing service capability exposure apparatus is provided and includes:
a first sending module, configured to send a first message to a second device, where the first message includes sensing service capability exposure information of a first device.

According to a fifth aspect, a sensing service capability exposure apparatus is provided and includes:
a first receiving module, configured to receive a first message sent by a first device, where the first message includes sensing service capability exposure information of the first device; and
a storage module, configured to store the sensing service capability exposure information of the first device.

According to a sixth aspect, a sensing service capability exposure apparatus is provided and includes:
a second sending module, configured to send a third message to a second device, where the third message is used to request information about a fifth device, and the fifth device supports exposure of sensing service data to a fourth device.

According to a seventh aspect, a terminal is provided. The terminal includes a processor and a memory. The memory stores a program or instructions executable on the processor. When the program or instructions are executed by the processor, the steps of the method according to the third aspect are implemented.

According to an eighth aspect, a terminal is provided and includes a processor and a communication interface. The communication interface is configured to send a third message to a second device, where the third message is used to request information about a fifth device, and the fifth device supports exposure of sensing service data to a fourth device.

According to a ninth aspect, a network-side device is provided. The network-side device includes a processor and a memory. The memory stores a program or instructions executable on the processor. When the program or instructions are executed by the processor, the steps of the method according to the first aspect or the second aspect or the third aspect are implemented.

According to a tenth aspect, a network-side device is provided and includes a processor and a communication interface. The network-side device is a first device, and the communication interface is configured to send a first message to a second device, where the first message includes sensing service capability exposure information of the first device.

Alternatively, the network-side device is a second device, and the communication interface is configured to receive a first message sent by a first device, where the first message includes sensing service capability exposure information of the first device; and the processor is configured to store the sensing service capability exposure information of the first device.

Alternatively, the network-side device is a fourth device, and the communication interface is configured to send a third message to a second device, where the third message is used to request information about a fifth device, and the fifth device supports exposure of sensing service data to the fourth device.

According to an eleventh aspect, a non-transitory readable storage medium is provided. The non-transitory readable storage medium stores a program or instructions. When the program or instructions are executed by a processor, the steps of the method according to the first aspect are implemented, or the steps of the method according to the second aspect are implemented, or the steps of the method according to the third aspect are implemented.

According to a twelfth aspect, a wireless communication system is provided and includes a first device, a second device, and a fourth device. The first device may be configured to perform the steps of the method according to the first aspect. The second device may be configured to perform the steps of the method according to the second aspect. The fourth device may be configured to perform the steps of the method according to the third aspect.

According to a thirteenth aspect, a chip is provided. The chip includes a processor and a communication interface. The communication interface is coupled to the processor. The processor is configured to run a program or instructions to implement the method according to the first aspect, or implement the method according to the second aspect, or implement the method according to the third aspect.

According to a fourteenth aspect, a computer program or program product is provided. The computer program or program product is stored in a non-transitory storage medium. The computer program or program product is executed by at least one processor to implement the method according to the first aspect, or implement the method according to the second aspect, or implement the method according to the third aspect.

### BRIEF DESCRIPTION OF THE DRAWINGS

FIG. 1 is a block diagram of a wireless communication system;

FIG. 2 is a schematic diagram of an architecture for communication and sensing service data capability exposure;

FIG. 3 is a first schematic flowchart of a method according to an embodiment of this application;

FIG. 4 is a second schematic flowchart of a method according to an embodiment of this application;

FIG. 5 is a third schematic flowchart of a method according to an embodiment of this application;

FIG. 6 is a first schematic application diagram of a method according to an embodiment of this application;

FIG. 7 is a second schematic application diagram of a method according to an embodiment of this application;

FIG. 8 is a schematic diagram of a modular structure of an apparatus corresponding to FIG. 3;

FIG. 9 is a schematic diagram of a modular structure of an apparatus corresponding to FIG. 4;

FIG. 10 is a schematic diagram of a modular structure of an apparatus corresponding to FIG. 5;

FIG. 11 is a schematic diagram of a structure of a communication device according to an embodiment of this application;

FIG. 12 is a schematic diagram of a structure of a terminal according to an embodiment of this application;

FIG. 13 is a schematic diagram of a structure of a network-side device according to an embodiment of this application; and

FIG. 14 is a schematic diagram of a structure of a network-side device according to another embodiment of this application.

### DESCRIPTION OF THE INVENTION

The following clearly describes the technical solutions in the embodiments of this application with reference to the accompanying drawings in the embodiments of this application. Apparently, the described embodiments are only some rather than all of the embodiments of this application. All other embodiments obtained by a person of ordinary skill in the art based on the embodiments of this application shall fall within the protection scope of this application.

The terms “first”, “second”, and the like in this application are used to distinguish between similar objects instead of describing a specified order or sequence. It should be understood that the terms used in this way are interchangeable in appropriate circumstances, so that the embodiments of this application can be implemented in other orders than the order illustrated or described herein. In addition, objects distinguished by “first” and “second” usually fall within one class, and a quantity of objects is not limited. For example, there may be one or more first objects. In addition, the term “or” in this application indicates at least one of connected objects. For example, “A or B” covers three schemes, that is, scheme 1: including A and excluding B; scheme 2: including B and excluding A; and scheme 3: including both A and B. The character “/” generally indicates an “or” relationship between associated objects.

The term “indication” in this application may be either a direct indication (or an explicit indication) or an indirect indication (or an implicit indication). The direct indication may be understood as follows: A sender explicitly notifies a receiver, in a sent indication, of content such as information, an operation to be performed, or a result being requested. The indirect indication may be understood as follows: A receiver determines corresponding information based on an indication sent by a sender, or makes a decision and determines, based on a decision result, an operation to be performed or a result being requested, or the like.

It should be noted that technologies described in the embodiments of this application are not limited to a long term evolution (LTE)/LTE-Advanced (LTE-A) system, and can also be used in other wireless communication systems, such as code division multiple access (CDMA), time division multiple access (TDMA), frequency division multiple access (FDMA), orthogonal frequency division multiple access (OFDMA), single-carrier frequency division multiple access (SC-FDMA), or other systems. The terms “system” and “network” in the embodiments of this application are usually used interchangeably. The described technologies may be used for the foregoing systems and radio technologies, and may also be used for other systems and radio technologies. However, in the following descriptions, a new radio (NR) system is described for an illustrative purpose, and NR terms are used in most of the following descriptions. These technologies may also be applied to other systems than the NR system, for example, a 6th Generation (6G) communication system.

FIG. 1 is a block diagram of a wireless communication system to which an embodiment of this application may be applied. The wireless communication system includes a terminal 11 and a network-side device 12. The terminal 11 may be a terminal-side device such as a mobile phone, a tablet personal computer, a laptop computer, a notebook computer, a personal digital assistant (PDA), a palmtop computer, a netbook, an ultra-mobile personal computer (UMPC), a mobile Internet device (MID), an augmented reality (AR) or virtual reality (VR) device, a robot, a wearable device, a flight vehicle, vehicle user equipment (VUE), shipborne equipment, pedestrian user equipment (PUE), a smart home (a home device having a wireless communication function, such as a refrigerator, a television, a washing machine, or furniture), a game console, a personal computer (PC), a teller machine, or a self-service machine. The wearable device includes a smartwatch, a smart band, a smart headphone, smart glasses, smart jewelry (a smart bracelet, a smart wrist chain, a smart ring, a smart necklace, a smart anklet, a smart ankle chain, or the like), a smart wristband, smart clothing, or the like. The vehicle user equipment may also be referred to as a vehicle-mounted terminal, a vehicle-mounted controller, a vehicle-mounted module, a vehicle-mounted component, a vehicle-mounted chip, a vehicle-mounted unit, or the like. It should be noted that a type of the terminal 11 is not limited in the embodiments of this application. The network-side device 12 may include an access network device or a core network device. The access network device may also be referred to as a radio access network (RAN) device, a radio access network function, or a radio access network element. The access network device may include a base station, a wireless local area network (WLAN) access point (AP), a wireless fidelity (Wi-Fi) node, or the like. The base station may be referred to as a NodeB (NB), an evolved NodeB (eNB), a next generation NodeB (gNB), a new radio NodeB (NR NodeB), an access point, a relay base station (RBS), a serving base station (SBS), a base transceiver station (BTS), a radio base station, a radio transceiver, a basic service set (BSS), an extended service set (ESS), a home NodeB (HNB), a home evolved NodeB, a transmission reception point (TRP), or another appropriate term in the art. As long as the same technical effect is achieved, the base station is not limited to specific technical terms. It should be noted that in the embodiments of this application, only a base station in an NR system is used as an example, but a type of the base station is not limited.

The core network device may include but is not limited to at least one of the following: a core network node, a core network function, a mobility management entity (MME), an access and mobility management function (AMF), a session management function (SMF), a user plane function (UPF), a policy control function (PCF), a policy and charging rules function (PCRF), an edge application server discovery function (EASDF), a unified data management (UDM), a unified data repository (UDR), a home subscriber server (HSS), a centralized network configuration (CNC), a network repository function (NRF), a network exposure function (NEF), a local NEF (L-NEF), a binding support function (BSF), an application function (AF), or the like. It should be noted that in the embodiments of this application, only a core network device in the NR system is used as an example for description, but a type of the core network device is not limited.

The following describes some concepts related to the embodiments of this application.

### I. Integrated Sensing and Communication:

In recent years, wireless communication and radar sensing (Communication & Sensing, C&S) have been developing in parallel, but an intersection thereof is limited. Wireless communication and radar sensing have many commonalities in signal processing algorithms, devices, and system architectures to some extent. In recent years, the two systems have drawn more attention of researchers in terms of coexistence, cooperation, and joint design.

Extensive research performed by people early on coexistence of communication and radar systems focuses on development of effective interference management technologies to enable two separately deployed systems to run smoothly without interfering with each other. Although radar and communication systems may be co-located or even physically integrated, they transmit two different types of signals in time/frequency domain. They cooperate to share same resources to minimize interference with each other while working simultaneously. Corresponding measures include beamforming, cooperative spectrum sharing, primary and secondary spectrum sharing, dynamic coexistence, and the like. However, effective interference cancellation usually has strict requirements on node mobility and information exchange between nodes. Therefore, an improvement of spectrum efficiency is actually limited. Because interference in the coexisting systems is caused by transmitting two independent signals, naturally, there is a question of whether one transmit signal can be used for both communication and radar sensing. The radar system usually uses specially designed waveforms, such as short pulses and chirps, which can implement high-power radiation and simplified receiver processing. However, these waveforms are not necessary for radar detection. For example, a passive radar or passive sensing uses different radio signals as sensing signals.

Machine learning, and in particular, a deep learning technology, promote use of non-dedicated radio signals for radar sensing. With these technologies, conventional radars are developing toward more universal wireless sensing. Wireless sensing herein may broadly refer to retrieving information from a received radio signal, rather than modulating communication data into a signal at a transmitter. For wireless sensing related to a location of a sensing target, common signal processing methods may be used to estimate a target signal reflection delay, an angle of arrival (AoA), an angle of departure (AoD), a Doppler parameter, and other dynamic parameters. Sensing of physical characteristics of the target can be implemented by using a measurement device or object, or an inherent pattern signal. The two sensing modes may be referred to as sensing parameter estimation and pattern recognition respectively. In this sense, wireless sensing refers to more general sensing technologies and applications that use radio signals.

Integrated sensing and communication (ISAC) has a potential to integrate wireless sensing into large-scale mobile networks, which are referred to as perceptive mobile networks (PMNs) herein. The PMN may evolve from a current 5th-generation (5G) mobile network and is expected to become a ubiquitous wireless sensing network while providing stable and high-quality mobile communication services. The PMN may be built on a mobile network infrastructure in the general art, and there is no need to make great changes to the network structure and devices. The PMN will unlock the full potential of the mobile network and avoid high infrastructure costs for separately constructing a new wide-area wireless sensing network. As coverage expands, integrated sensing and communication capabilities are expected to implement many new applications. The perceptive mobile network can provide both communication and wireless sensing services, and will probably become a ubiquitous wireless sensing solution due to its large broadband coverage and strong infrastructure. Its jointly coordinated communication and sensing capabilities will increase productivity of our society and help produce plenty of new applications that cannot be effectively implemented by the sensor network in the general art. Its potential has been proved in some early work using mobile signals for passive sensing, such as traffic monitoring, weather forecast, and rainfall remote sensing based on global system for mobile communications (GSM) radio signals. The perceptive mobile network can be widely applied to communication and sensing in the fields of transportation, communication, energy, precision agriculture, and security. However, solutions in the general art are either unfeasible or inefficient. The perceptive mobile network can also provide complementary sensing capabilities for the sensor network in the general art, featuring unique day-and-night operation and the capability to penetrate fog, foliage, and even solid objects.

### II. Architecture for Communication and Sensing Service Data Capability Exposure

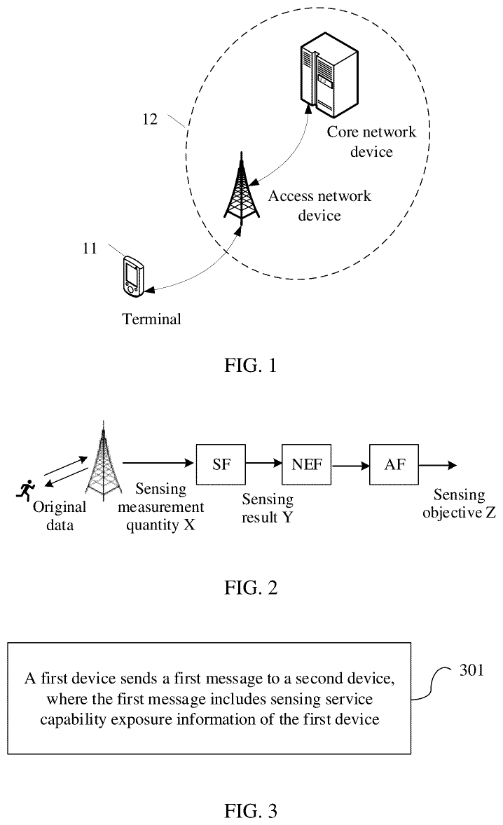

As shown in FIG. 2, in the architecture, an SF is a network element added for a communication and sensing service. The SF is responsible for managing and controlling the communication and sensing service and processing communication and sensing data. The SF may be one network element, which is responsible for both a user plane and a control plane. Alternatively, the SF may be two network elements, that is, the user plane and the control plane are separated. For example, the control plane is a sensing function control plane device (SF-C), and the user plane is a sensing function user plane device (SF-U). For example, sensing measurement quantities include a time delay, Doppler, an angle, strength, and multidimensional combinations thereof. A sensing result is a result obtained by the SF after the sensing measurement is processed, for example, an intermediate processing result such as a speed, a distance, an orientation, an acceleration, a location, a trajectory, or an action. A sensing objective is a final result obtained by an application function (AF), such as traffic violation or road congestion.

The control plane receives and processes signaling related to the sensing service, and implements corresponding selection and control on a sensing service device, mode selection, a processing mode, and the like. The user plane receives and processes related sensing service data and generates a corresponding processing result.

However, how to make sensing service data generated by the SF accessible and usable has become an urgent technical problem to be resolved.

A sensing service capability exposure method provided in the embodiments of this application is hereinafter described in detail by using some embodiments and application scenarios thereof with reference to the accompanying drawings.

As shown in FIG. 3, a sensing service capability exposure method according to an embodiment of this application includes:

Step 301: A first device sends a first message to a second device, where the first message includes sensing service capability exposure information of the first device.

By performing this step, the first device notifies the sensing service capability exposure information of the first device to the second device, so that the second device stores the information. In this way, access of a consumer device to the first device can be controlled, and sensing service data can be effectively accessed and used.

In an implementation, the first device includes an SF, or another network element having a sensing function; and the second device includes an NRF, a NEF, a UDM, or an AMF, or another network element having an information storage function.

For example, the first device is the SF and the second device is the NRF. The SF sends a first message including sensing service capability exposure information of the SF to the NRF. The first message may be a network element registration message, a network element capability report, an update message, or the like.

Optionally, in this embodiment, the sensing service capability exposure information includes at least one of the following:
first information, used to indicate an exposure scope of a sensing service;
second information, used to indicate a usage scope of the sensing service; or
third information, used to indicate a usage purpose of the sensing service.

The exposure scope of the sensing service is information about a device (object) to which sensing service data of the first device is allowed to be exposed. The information about the device (object) to which the sensing service data of the first device is allowed to be exposed includes information about a third device.

Optionally, the first information or the information about the third device includes at least one of the following:
identification information of the third device;
information about a consumer type or a device type to which the third device belongs;
vendor information of the third device;
token information of the third device;
public land mobile network (PLMN) information of the third device;
slice information corresponding to the third device; or
a data network name (DNN) corresponding to the third device, where
the third device is a device to which the sensing service data of the first device is allowed to be exposed.

Herein, the identification information of the third device is used to indicate that the sensing service data of the first device is allowed to be exposed to a device (object) corresponding to the identification information. The information about the consumer type or the device type to which the third device belongs is used to indicate that the sensing service data of the first device is allowed to be exposed to a device (object) corresponding to the consumer type or the device type. The vendor information of the third device is used to indicate that the sensing service data of the first device is allowed to be exposed to a device (object) from the vendor. The token information of the third device is used to indicate that the sensing service data of the first device is allowed to be exposed to a device (object) holding the token. The PLMN information of the third device is used to indicate that the sensing service data of the first device is allowed to be exposed to an object in the PLMN. The slice information corresponding to the third device is used to indicate that the sensing service data of the first device is allowed to be exposed to a device (object) in the slice. The DNN corresponding to the third device is used to indicate that the sensing service data of the first device is allowed to be exposed to a device (object) connected to the DNN.

In addition, the usage scope of the sensing service is a scope in which the sensing service data of the first device is used, and includes at least one of a time scope or an area scope. The time scope may be a specific time period or a periodic time period. The area scope may be an area indicated by a network area identifier (such as an area indicated by a tracking area identity (TAI) or a cell identity (cell ID), or may be a geographical area representation or other representations.

The usage purpose of the sensing service is a purpose for which the sensing service data of the first device is allowed to be used or forbidden to be used. For example, the allowed usage purpose includes: weather forecast, crowd flow forecast, detection of intrusion of an uncrewed aerial vehicle, and the like; and the forbidden usage purpose includes: monitoring a single human body movement or posture, user privacy detection, and the like. The usage purpose may be represented in a form of a text or a character string; or may be represented in a form of numeric symbols. Different numeric symbols represent different purposes. For example, 0001 represents weather forecast, and 0010 represents detection of a human body movement or posture.

Optionally, in this embodiment, the sensing service capability exposure information corresponds to at least one piece of the following information:
identification information of the sensing service; or
fourth information, used to indicate a sensing scope of the sensing service.

It may be understood that the first message further includes at least one of the identification information of the sensing service or the fourth information.

In an implementation, the identification information of the sensing service refers to a type of sensing service that can be supported by the first device. For different sensing services, the first device may have the same or different sensing service capability exposure information. The identification information of the sensing service may be represented in different ways, such as a sensing service type or a sensing service identifier (sensing service ID).

In an implementation, the first device may send the sensing service capability exposure information to the second device based on a granularity of the sensing service.

In an implementation, the sensing scope of the sensing service refers to a scope of the sensing service that the first device can provide.

Optionally, the sensing scope of the sensing service includes at least one of the following: a sensing time scope; or a sensing area scope.

The sensing time scope refers to a time period or a time point at which the first device can provide the sensing service; and the sensing area scope refers to an area in which the first device can provide the sensing service, where the area may be a service area of the first device or a sub-area in a service area of the first device.

In an implementation, the sensing service capability exposure information in the first message corresponds to one or more sensing services that can be supported by the first device, or corresponds to one or more sensing scopes of the sensing service that can be provided by the first device.

Optionally, the first message further includes at least one of the following:
the identification information of the sensing service; or
the fourth information.

In other words, in a case that the first message includes the sensing service capability exposure information, the type or the sensing scope of the sensing service corresponding to the sensing service capability exposure information may be further indicated.

Optionally, the first message further includes at least one of the following:
identification information of the first device;
network element type information of the first device, where the network element type information is used to indicate that the first device is a network element supporting a sensing service control function; or
a name of a service supported by the first device, where the service includes a sensing capability exposure service.

In an implementation, the identification information of the first device may be a network element instance identifier, a fully qualified domain name (FQDN), an Internet Protocol (IP) address, or other representations. The network element type information of the first device may be information indicating a sensing function type (SF type), that is, a network function (NF) type in the first message is set to information indicating the SF type, such as NF type=SF type. The name of the service supported by the first device may be that a supported service name in the first message is set to information indicating that the first device supports a sensing control service, for example, supported service name=sensing management indicates that the first device supports the sensing control service.

In an implementation, the second device stores the sensing service capability exposure information of the first device in the first message. Certainly, the second device may store sensing service capability exposure information of a plurality of different first devices. Therefore, in a case that a fourth device (that is, the consumer device) requests exposure of sensing service data to the fourth device, the second device determines a fifth device for the fourth device based on the stored sensing service capability exposure information, so that the fourth device can obtain required sensing service data.

In an implementation, the fifth device is one of one or more first devices registered/updated/stored in the second device.

Optionally, in this embodiment, the method further includes:
the first device receives a second message sent by a fourth device, where the second message is used to request a sensing service; and
the first device performs the sensing service based on the second message, and sends obtained sensing service data to the fourth device.

In this case, the first device is the fifth device determined by the second device for the fourth device. After receiving the second message from the fourth device, the first device performs the sensing service and notifies the fourth device of the obtained sensing service data.

Optionally, the second message includes at least one of the following:
a type of the requested sensing service, such as a specific sensing service type, used to indicate that sensing service data corresponding to the specific sensing service type is requested;
identification information of the requested sensing service, such as a specific sensing service identifier (Specific sensing service ID), used to indicate that sensing service data corresponding to the specific sensing service ID is requested;
a usage purpose of the requested sensing service data, used to indicate a usage purpose of the sensing service data that the fourth device requests to obtain;
a usage scope of the requested sensing service data, used to indicate a usage scope of the sensing service data that the fourth device requests to obtain;
identification information of the fourth device, used to uniquely identify the fourth device;
vendor information of the fourth device, used to indicate a vendor corresponding to the fourth device, or a vendor providing the fourth device;
token information of the fourth device, used to indicate information about a sensing service invocation token held by the fourth device, where the token information may be obtained from a service agreement between the fourth device and an operator network, or obtained from a prior offline interconnection and debugging process between the first device and the fourth device;
PLMN information of the fourth device, such as a PLMN ID, used to indicate an ID of a PLMN in which the fourth device is located;
slice information corresponding to the fourth device, used to indicate a slice in which the fourth device is located, such as single network slice selection assistance information (S-NSSAI) or a network slice instance (NSI) ID; or
a DNN corresponding to the fourth device.

In this way, after receiving the second message, the first device can perform the corresponding sensing service and feed back the sensing service data required by the fourth device to the fourth device.

Optionally, the first device performs at least one of the following based on the second message: selecting a sensing mode, selecting a sensing device, sending sensing task signaling, or obtaining and collecting the sensing service data. For example, the first device performs corresponding processing based on the specific sensing service type, including but not limited to: selecting a specific sensing mode, selecting a specific sensing device, sending sensing task signaling, and obtaining and collecting the sensing service data.

Optionally, the second message includes fifth information, and the fifth information corresponds to at least one piece of the following information in the first device:
an execution mode of the sensing service;
a processing mode of the sensing service data;
a sending mode of the sensing service data; or
a format of the sensing service data.

Herein, the execution mode of the sensing service includes defining a quality of service requirement, a sensing mode, a measurement quantity, a measurement method, and the like for the sensing service; the processing mode of the sensing service data includes whether to perform security encryption/desensitization, an encryption/desensitization mode, and the like; the sending mode of the sensing service data includes defining sending of the sensing service data in a container mode, and may be used to define a sensing service data feedback time, a feedback condition, the number of feedback times, and a minimum/maximum amount of data in a single feedback; and the format of the sensing service data includes defining a format representation of the sensing service data (such as a text, a character string, or binary notation).

The fifth information may be obtained from the service agreement between the fourth device and the operator network, or obtained from the prior offline interconnection and debugging process between the fifth device and the fourth device. A purpose of the fifth information is to negotiate and synchronize the foregoing information between the fifth device and the consumer device, but how to process and implement the foregoing is transparent or imperceptible to other devices, and is only known privately by the two parties. For example, the second message includes fifth information, where the fifth information is a token, a character string, or a combination of numbers.

Optionally, the sending mode includes sending the sensing service data in a container mode.

In other words, the first device sends the sensing service data required by the fourth device to the fourth device in a corresponding container mode based on the fifth information. The sending in the container mode enables both the sending and receiving parties to know content of the sensing service data, while other devices cannot parse data content in the container, thereby ensuring security of the data. In addition, for the sending in the container mode, there is no need to standardize the mode and format of sending and receiving data, but only private negotiation is required between the sending and receiving parties. This is conducive to improving transmission efficiency of the sensing service data.

Optionally, the container mode includes at least one of the following:
a preset container mode; or
a container mode corresponding to a value of the fifth information.

In other words, if the container mode is the preset container mode, even if the value of the fifth information varies, the first device sends sensing service data corresponding to different fifth information in a same container mode; or if the container mode is the container mode corresponding to the value of the fifth information, the first device sends sensing service data in different container modes based on different values of the fifth information. For example, if the fifth information is the token information of the fourth device, the first device may send sensing service data corresponding to different tokens in a same container mode regardless of a value of the token; or the first device may send the sensing service data in different container modes for different token values.

Optionally, that the first device performs the sensing service based on the second message, and sends obtained sensing service data to the fourth device includes:
the first device determines, based on the second message, whether the corresponding sensing service data is allowed to be exposed to the fourth device; and
in a case that the corresponding sensing service data is allowed to be exposed to the fourth device, the first device performs the sensing service, and sends the obtained sensing service data to the fourth device.

In other words, in this case, the first device is considered by the second device to be the fifth device that matches the fourth device, that is, the first device can expose the sensing service data to the fourth device. For example, a PLMN ID of the first device matches a PLMN ID of a device expected by the fourth device, vendor information of the first device matches vendor information of the device expected by the fourth device, token information of the first device matches token information of the device expected by the fourth device, a DNN corresponding to the first device matches a DNN corresponding to the device expected by the fourth device, slice information corresponding to the first device matches slice information corresponding to the device expected by the fourth device, the usage purpose of the sensing service defined by the first device matches the usage purpose of the sensing service data requested by the fourth device, or the usage scope of the sensing service defined by the first device matches the usage scope of the sensing service data requested by the fourth device.

Optionally, after receiving the second message (Specific sensing service type), the first device determines, based on the information in the second message, whether the corresponding sensing service data is allowed to be exposed to the fourth device, and send the corresponding sensing service data (such as the sensing service data corresponding to the specific sensing service type) to the fourth device only when the corresponding sensing service data is allowed to be exposed to the fourth device. In this way, determining the fourth device twice by the first device is conducive to more accurate access control.

Optionally, the fourth device sends a third message to the second device, where the third message is used to request information about a fifth device, and the fifth device supports exposure of sensing service data to the fourth device; and the second device can determine, based on the third message and the stored sensing service capability exposure information of the first device, whether the fifth device exists. In other words, the second device matches the fifth device with the fourth device.

Optionally, in a case that it is determined that the fifth device exists, the second device sends a fifth message, that is, information about the fifth device, to the fourth device, so that the fourth device can request a sensing service from the fifth device. However, in a case that it is determined that the fifth device does not exist, the second device sends a fourth message to the fourth device, indicating that the fifth device does not exist or cause information for nonexistence of the fifth device.

In this embodiment, the fourth device refers to a consumer device of the sensing service, and may include an AF, an NF, a terminal, a base station, or the like.

If the second device is the NRF, the fourth device may be the AF, and when the AF is a trusted service server, the AF directly sends a third message to the NRF, where the third message may be a network element query request message, such as Nnrf_NFDiscovery_Request service operation, or the third message may be a network element status acquisition request message, such as nrf_NFManagement_NFStatusSubscribe.

If the second device is the NRF, the fourth device may be the AF, and when the AF is an untrusted third-party service server, the NEF, in place of the AF, sends a third message to the NRF. For example, the AF may send a sensing network element query message (used to request to query SF instances corresponding to a specific sensing service) or a sensing service request message (directly used to request a specific sensing service to obtain sensing information) to the NEF; and the NEF sends a third message to the NRF based on the request of the AF, where the third message is a network element query request message, such as Nnrf_NFDiscovery_Request service operation, or the third message is a network element discovery request message.

If the second device is the NRF and the fourth device is the terminal or the base station, the terminal or the base station may send a third message to the NRF through the AMF. If the second device is the AMF and the fourth device is the terminal or the base station, the terminal or the base station may directly send a third message to the AMF.

As shown in FIG. 4, a sensing service capability exposure method according to an embodiment of this application includes:

Step 401: A second device receives a first message sent by a first device, where the first message includes sensing service capability exposure information of the first device.

Step 402: The second device stores the sensing service capability exposure information of the first device.

In other words, the second device receives the first message from the first device, and stores the sensing service capability exposure information of the first device, to prepare for subsequent control over access of a consumer device to the first device, so that sensing service data can be effectively accessed and used.

The second device can store sensing service capability exposure information of one or a plurality of different first devices.

Optionally, the sensing service capability exposure information includes at least one of the following:
first information, used to indicate an exposure scope of a sensing service;
second information, used to indicate a usage scope of the sensing service; or
third information, used to indicate a usage purpose of the sensing service.

Optionally, the first information includes at least one of the following:
identification information of a third device;
information about a consumer type or a device type to which the third device belongs;
vendor information of the third device;
token information of the third device;
public land mobile network PLMN information of the third device;
slice information corresponding to the third device; or
a data network name DNN corresponding to the third device, where
the third device is a device to which sensing service data of the first device is allowed to be exposed.

Optionally, in this embodiment, the method further includes:
the second device receives a third message sent by a fourth device, where the third message is used to request information about a fifth device, and the fifth device supports exposure of sensing service data to the fourth device; and
the second device determines, based on the third message and the stored sensing service capability exposure information of the first device, whether the fifth device exists.

In other words, the second device can match the fifth device with the fourth device for the third message of the fourth device. For example, the second device, such as an NRF, determines whether one or more SF entities exist, where the one or more SF entities can expose sensing service data to the fourth device such as an AF.

Optionally, the third message includes at least one of the following:
a type of a requested sensing service, such as a specific sensing service type, used to indicate a first device corresponding to the specific sensing service type that the fourth device requests to obtain;
identification information of the requested sensing service, such as a specific sensing service ID, used to indicate a first device corresponding to the specific sensing service ID that the fourth device requests to obtain;
a usage purpose of requested sensing service data, used to indicate a usage purpose of the sensing service data that the fourth device requests to obtain;
a usage scope of the requested sensing service data, used to indicate a usage scope of the sensing service data that the fourth device requests to obtain;
identification information of the fourth device, used to uniquely identify the fourth device;
vendor information of the fourth device, used to indicate a vendor corresponding to the fourth device, or a vendor providing the fourth device;
token information of the fourth device, used to indicate information about a sensing service invocation token held by the fourth device, where the token information may be obtained from a service agreement between the fourth device and an operator network, or obtained from a prior offline interconnection and debugging process between the first device and the fourth device;
PLMN information of the fourth device, such as a PLMN ID, used to indicate an ID of a PLMN in which the fourth device is located;
slice information corresponding to the fourth device, used to indicate a slice in which the fourth device is located, such as an S-NSSAI or an NSI ID; or
a DNN corresponding to the fourth device.

Herein, the third message includes information about the fourth device.

Optionally, the third message includes at least one of the following:
vendor information of the fifth device, used to indicate a vendor corresponding to a device expected by the fourth device, or a vendor providing a device expected by the fourth device;
PLMN information of the fifth device, such as a PLMN ID, used to indicate an ID of a PLMN in which the device expected by the fourth device is located;
slice information corresponding to the fifth device, used to indicate a slice in which the device expected by the fourth device is located, such as an S-NSSAI or an NSI ID;
a DNN corresponding to the fifth device, used to indicate a DNN corresponding to the device expected by the fourth device;
network element type information of the fifth device, where the network element type information is used to indicate that the fifth device is a network element supporting a sensing service control function, and used to indicate that the device expected by the fourth device is a network element supporting the sensing service control function, for example, an NF type in the third message is set to an SF type, for example, NF type=SF type; or
identification information of the fifth device, used to uniquely identify the device expected by the fourth device.

In other words, the third message includes information about the device expected by the fourth device. Certainly, the third message may also include token information of the device expected by the fourth device.

Optionally, that the second device determines, based on the third message and the stored sensing service capability exposure information of the first device, whether the fifth device exists includes:
determining whether the sensing service capability exposure information of the first device matches target information of the fourth device; and
in a case that the sensing service capability exposure information of the first device matches the target information of the fourth device, determining that the fifth device exists; or
in a case that the sensing service capability exposure information of the first device does not match the target information of the fourth device, determining that the fifth device does not exist, where
the target information includes at least one of the following:
vendor information;
token information;
a usage purpose of requested sensing service data; or
a usage scope of the requested sensing service data.

Therefore, in a process of determining matching, one or more of the following can be performed: determining whether the vendor information of the fourth device matches the sensing service capability exposure information of the first device;
determining whether the token information of the fourth device matches the sensing service capability exposure information of the first device;
determining whether the usage purpose of the requested sensing service data matches the sensing service capability exposure information of the first device; and
determining whether the usage scope of the requested sensing service data matches the sensing service capability exposure information of the first device.

In an implementation, the target information may further include one or more of the following: the identification information of the fourth device, the PLMN information of the fourth device, the slice information corresponding to the fourth device, PLMN information of the device expected by the fourth device, vendor information of the device expected by the fourth device, token information of the device expected by the fourth device, the DNN corresponding to the device expected by the fourth device, and slice information corresponding to the device expected by the fourth device.

In an implementation, when the target information includes one piece of information in the foregoing content, if sensing service capability exposure information of one or more first devices matches the one piece of information, it is determined that the fifth device exists, and the one or more first devices are fifth devices; or if sensing service capability exposure information of no first device matches the one piece of information, it is determined that the fifth device does not exist. When the target information includes a plurality of pieces of information in the foregoing content, if sensing service capability exposure information of one or more first devices matches the plurality of pieces of information, it is determined that the fifth device exists, and the one or more first devices are fifth devices; or if sensing service capability exposure information of no first device matches the plurality of pieces of information, it is determined that the fifth device does not exist.

In an implementation, at least one of the following determinations is performed based on the third message and the stored sensing service capability exposure information of the first device:
determining whether the identification information of the fourth device matches the sensing service capability exposure information of the first device;
determining whether the PLMN information of the fourth device matches the sensing service capability exposure information of the first device;
determining whether the slice information corresponding to the fourth device matches the sensing service capability exposure information of the first device;
determining whether the DNN corresponding to the fourth device matches the sensing service capability exposure information of the first device;
determining whether the PLMN information of the device expected by the fourth device matches the sensing service capability exposure information of the first device;
determining whether the vendor information of the device expected by the fourth device matches the sensing service capability exposure information of the first device;
determining whether the token information of the device expected by the fourth device matches the sensing service capability exposure information of the first device;
determining whether the DNN corresponding to the device expected by the fourth device matches the sensing service capability exposure information of the first device; or
determining whether the slice information corresponding to the device expected by the fourth device matches the sensing service capability exposure information of the first device.

In this way, after the foregoing determinations are performed, the matched first device can be used as the fifth device.

For example, the second device NRF determines that a specific SF entity as the fifth device can expose sensing data to the fourth device such as the AF, which may include in any one of the following cases:
if the NRF determines that identification information of the AF matches exposure scope information of a sensing service of an SF;
if the NRF determines that vendor information of the AF matches exposure scope information of a sensing service of an SF;
if the NRF determines that token information of the AF matches exposure scope information of a sensing service of an SF;
if the NRF determines that a PLMN ID of the AF matches exposure scope information of a sensing service of an SF;
if the NRF determines that a DNN corresponding to the AF matches exposure scope information of a sensing service of an SF;
if the NRF determines that slice information corresponding to the AF matches exposure scope information of a sensing service of an SF;
if the NRF determines that a PLMN ID of an expected SF matches exposure scope information of a sensing service of an SF;
if the NRF determines that vendor information of an expected SF matches exposure scope information of a sensing service of an SF;
if the NRF determines that token information of an expected SF matches exposure scope information of a sensing service of an SF;
if the NRF determines that a DNN corresponding to an expected SF matches exposure scope information of a sensing service of an SF;
if the NRF determines that slice information corresponding to an expected SF matches exposure scope information of a sensing service of an SF;
if the NRF determines that a usage purpose of requested sensing service data matches a usage purpose of a sensing service defined by an SF; or
if the NRF determines that a usage scope of requested sensing service data matches a usage scope of a sensing service defined by an SF.

Optionally, in this embodiment, the fifth device meets at least one of the following that:
vendor information of the fifth device matches the vendor information of the fourth device;
token information of a device to which the sensing service data of the fifth device is allowed to be exposed matches the token information of the fourth device;
a usage purpose of the sensing service data of the fifth device matches a usage purpose of sensing service data requested by the fourth device; or
a usage scope of the sensing service data of the fifth device matches a usage scope of the sensing service data requested by the fourth device.

Certainly, the condition met by the fifth device varies depending on different definitions of the target information, and examples thereof are not provided herein.

Optionally, in this embodiment, that the sensing service capability exposure information of the first device matches the target information of the fourth device may be understood as “the sensing service capability exposure information of the first device is consistent with the target information of the fourth device”, or may be understood as “the target information of the fourth device is within coverage of the sensing service capability exposure information of the first device”. For example, the token information of the device to which the sensing service data of the first device is allowed to be exposed matches the token information of the fourth device, that is, the token information of the device to which the sensing service data of the first device is allowed to be exposed includes the token information of the fourth device; and the vendor information of the first device matches the vendor information of the fourth device, that is, the vendor information of the first device is consistent with the vendor information of the fourth device.

Optionally, in this embodiment, the method further includes:
in a case that it is determined that the fifth device does not exist, the second device sends a fourth message to the fourth device, where the fourth message includes at least one of the following:
sixth information, used to indicate that the fifth device does not exist; or
seventh information, used to indicate cause information for nonexistence of the fifth device, where
the cause information includes at least one of the following that: the fourth device is not a device corresponding to the sensing service capability exposure information of the first device; a usage purpose of requested sensing service data is not allowed by the first device; or a usage scope of the requested sensing service data does not match that of the sensing service capability exposure information of the first device.

Herein, the sixth information may indicate that no first device that can expose sensing service data to the fourth device is found or exists; and the seventh information may indicate why no first device that can expose sensing service data to the fourth device is found or exists. For example, the fourth device is not within an allowable scope (for example, a vendor of the fourth device is A, and none of exposure scopes of sensing services of all first devices includes the vendor A); the usage purpose of the sensing service data of the fourth device is not allowed (for example, the fourth device expects to use the sensing service data for weather forecast, and none of usage scopes of sensing services of all first device includes weather forecast); or the usage scope of the fourth device is not allowed (for example, the fourth device is in an area A, and none of exposure scopes of sensing services of all first devices includes the area A).

Optionally, the method further includes:
in a case that it is determined that the fifth device exists, the second device sends a fifth message to the fourth device, where the fifth message includes at least one of the following:
vendor information of the fifth device, used to indicate a vendor corresponding to the fifth device, or a vendor providing the fifth device;
PLMN information of the fifth device, such as a PLMN ID, used to indicate an ID of a PLMN in which the fifth device is located;
slice information corresponding to the fifth device, used to indicate a slice in which the fifth device is located, such as an S-NSSAI or an NSI ID;
a DNN corresponding to the fifth device;
network element type information of the fifth device, where the network element type information is used to indicate that the fifth device is a network element supporting a sensing service control function, and used to indicate that the fifth device is a network element supporting the sensing service control function, for example, an NF type in the fifth message is set to an SF type, for example, NF type=SF type;
identification information of the fifth device, used to uniquely identify the fifth device;
a usage purpose of the sensing service data of the fifth device, used to indicate the usage purpose of the sensing service data of the fifth device;
a usage scope of the sensing service data of the fifth device, used to indicate the usage scope of the sensing service data of the fifth device; or
a sensing scope of a sensing service of the fifth device.

In other words, the second device notifies the fourth device of the information about the fifth device matching the fourth device, so that the fourth device can request a sensing service from the fifth device.

If the second device is the NRF, and the fourth device is the AF, when the AF is a trusted service server, the NRF may directly send a fourth message or a fifth message, for example, a network element query response message, to the AF; or when the AF is an untrusted third-party service server, the NRF may first send a fourth message or a fifth message, such as a network element query response message, to a NEF, and then the NEF sends a fourth message or a fifth message, such as a network element query response message or a sensing service response message, to the AF.

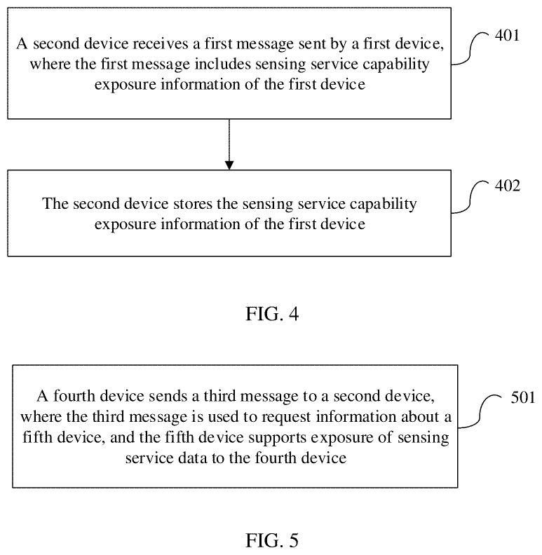

As shown in FIG. 5, a sensing service capability exposure method according to an embodiment of this application includes:

Step 501: A fourth device sends a third message to a second device, where the third message is used to request information about a fifth device, and the fifth device supports exposure of sensing service data to the fourth device.

In other words, the fourth device sends the third message to the second device, so that the second device can respond to access of a consumer device to a first device for control and that sensing service data can be effectively accessed and used.

In this embodiment, the fourth device refers to a consumer device of a sensing service, and may include an AF, an NF, a terminal, a base station, or the like.

Optionally, the third message includes at least one of the following:
a type of a requested sensing service, such as a specific sensing service type, used to indicate a first device corresponding to the specific sensing service type that the fourth device requests to obtain;
identification information of the requested sensing service, such as a specific sensing service ID, used to indicate a first device corresponding to the specific sensing service ID that the fourth device requests to obtain;
a usage purpose of requested sensing service data, used to indicate a usage purpose of the sensing service data that the fourth device requests to obtain;
a usage scope of the requested sensing service data, used to indicate a usage scope of the sensing service data that the fourth device requests to obtain;
identification information of the fourth device, used to uniquely identify the fourth device;
vendor information of the fourth device, used to indicate a vendor corresponding to the fourth device, or a vendor providing the fourth device;
token information of the fourth device, used to indicate information about a sensing service invocation token held by the fourth device, where the token information may be obtained from a service agreement between the fourth device and an operator network, or obtained from a prior offline interconnection and debugging process between the first device and the fourth device;
PLMN information of the fourth device, such as a PLMN ID, used to indicate an ID of a PLMN in which the fourth device is located;
slice information corresponding to the fourth device, used to indicate a slice in which the fourth device is located, such as an S-NSSAI or an NSI ID; or
a DNN corresponding to the fourth device.

Optionally, the third message includes at least one of the following:
vendor information of the fifth device, used to indicate a vendor corresponding to a device expected by the fourth device, or a vendor providing a device expected by the fourth device;
PLMN information of the fifth device, such as a PLMN ID, used to indicate an ID of a PLMN in which the device expected by the fourth device is located;
slice information corresponding to the fifth device, used to indicate a slice in which the device expected by the fourth device is located, such as an S-NSSAI or an NSI ID;
a DNN corresponding to the fifth device, used to indicate a DNN corresponding to the device expected by the fourth device;
network element type information of the fifth device, where the network element type information is used to indicate that the fifth device is a network element supporting a sensing service control function, and used to indicate that the device expected by the fourth device is a network element supporting the sensing service control function, for example, an NF type in the third message is set to an SF type, for example, NF type=SF type; or
identification information of the fifth device, used to uniquely identify the device expected by the fourth device.

Optionally, the method further includes:
the fourth device receives a fourth message sent by the second device, where the fourth message includes at least one of the following:
sixth information, used to indicate that the fifth device does not exist; or
seventh information, used to indicate cause information for nonexistence of the fifth device, where
the cause information includes at least one of the following that: the fourth device is not a device corresponding to sensing service capability exposure information of the first device; a usage purpose of requested sensing service data is not allowed by the first device; or a usage scope of the requested sensing service data does not match that of the sensing service capability exposure information of the first device.

Herein, the fourth message sent by the second device is sent in a case that the second device determines that the fifth device does not exist.

The sixth information may indicate that no first device that can expose sensing service data to the fourth device is found or exists; and the seventh information may indicate why no first device that can expose sensing service data to the fourth device is found or exists. For example, the fourth device is not within an allowable scope (for example, a vendor of the fourth device is A, and none of exposure scopes of sensing services of all first devices includes the vendor A); the usage purpose of the sensing service data of the fourth device is not allowed (for example, the fourth device expects to use the sensing service data for weather forecast, and none of usage scopes of sensing services of all first device includes weather forecast); or the usage scope of the fourth device is not allowed (for example, the fourth device is in an area A, and none of exposure scopes of sensing services of all first devices includes the area A).

Optionally, the method further includes:
the fourth device receives a fifth message sent by the second device, where the fifth message includes at least one of the following:
vendor information of the fifth device, used to indicate a vendor corresponding to the fifth device, or a vendor providing the fifth device;
PLMN information of the fifth device, such as a PLMN ID, used to indicate an ID of a PLMN in which the fifth device is located;
slice information corresponding to the fifth device, used to indicate a slice in which the fifth device is located, such as an S-NSSAI or an NSI ID;
a DNN corresponding to the fifth device;
network element type information of the fifth device, where the network element type information is used to indicate that the fifth device is a network element supporting a sensing service control function, and used to indicate that the fifth device is a network element supporting the sensing service control function, for example, an NF type in the fifth message is set to an SF type, for example, NF type=SF type;
identification information of the fifth device, used to uniquely identify the fifth device;
a usage purpose of the sensing service data of the fifth device, used to indicate the usage purpose of the sensing service data of the fifth device;
a usage scope of the sensing service data of the fifth device, used to indicate the usage scope of the sensing service data of the fifth device; or
a sensing scope of a sensing service of the fifth device.

In other words, the fourth device receives information about the fifth device that the second device matches for the fourth device, so that the fourth device can request a sensing service from the fifth device.

Optionally, the method further includes:
the fourth device sends a second message to the fifth device, where the second message is used to request a sensing service; and
the fourth device receives sensing service data sent by the fifth device.

It should be noted that an order in which the fourth device sends the second message and the third message is not fixed. The fourth device may send the second message before the third message, or send the third message before the second message, or send the two messages simultaneously. In other words, it is not necessary to query the fifth device before the fourth device requests to perform the sensing service.

Optionally, the second message includes at least one of the following:
a type of the requested sensing service;
identification information of the requested sensing service;
a usage purpose of requested sensing service data;
a usage scope of the requested sensing service data;
identification information of the fourth device;
vendor information of the fourth device;
token information of the fourth device;
PLMN information of the fourth device;
slice information corresponding to the fourth device; or
a DNN corresponding to the fourth device.

Optionally, the second message includes fifth information, and the fifth information corresponds to at least one piece of the following information in the first device:
an execution mode of the sensing service;
a processing mode of the sensing service data;
a sending mode of the sensing service data; or
a format of the sensing service data.

Optionally, the sending mode includes sending the sensing service data in a container mode.

Optionally, the container mode includes at least one of the following:
a preset container mode; or
a container mode corresponding to a value of the fifth information.

The following describes applications of the method embodiments of this application with reference to some scenarios.

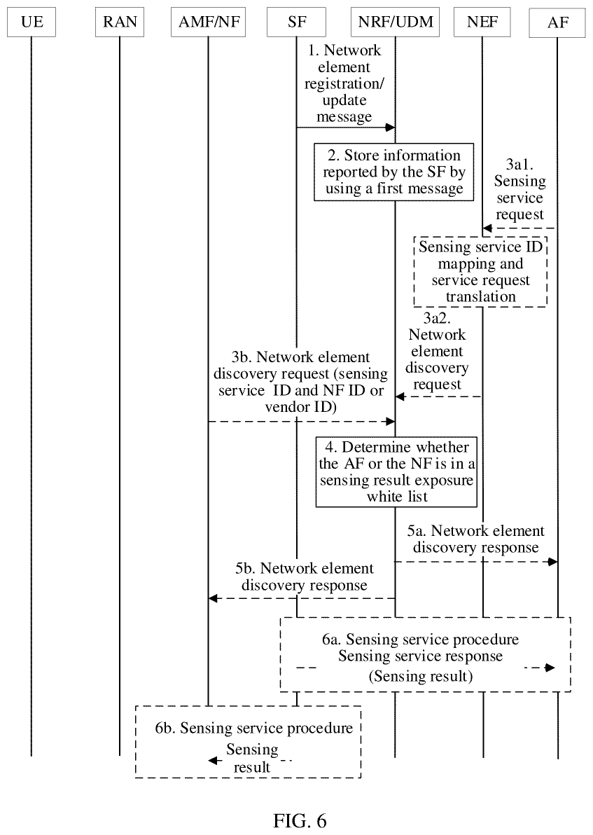

Scenario 1: An example in which a first device is an SF and a second device is an NRF or a UDM is used for description. As shown in FIG. 6, the method includes the following steps.

Step 1: The SF sends a first message (such as a network element registration/update message) to the NRF or the UDM. The first message includes identification information of the SF (such as an SF ID), identification information of a sensing service (sensing service ID), and sensing service capability exposure information, for example, first information (such as sensing result exposure information (sensing result exposure info)) (such as consumer identifiers (consumer IDs) or a vendor list of consumers), second information (such as a usage time/area), and third information (such as a usage purpose).

Step 2: The NRF or the UDM stores the information reported by the SF by using the first message.

Step 3a: An AF sends a third message to the NRF to query an SF network element entity corresponding to the sensing service. When the AF is a trusted service server, the AF directly sends the third message to the NRF, which is not shown in the figure. When the AF is an untrusted third-party service server, a NEF, in place of the AF, sends the third message to the NRF. For example, in step 3a1, the AF sends a sensing service request message to the NEF; and in step 3a2, the NEF sends, to the NRF or the UDM, a network element discovery request message, including the sensing service ID, and the AF ID or a vendor ID. After receiving the sensing service request message, the NEF performs sensing service ID mapping and service request translation.

Step 3b: An AMF or an NF sends a third message (such as a network element discovery request message) to the NRF to query the SF network element entity corresponding to the sensing service. Certainly, UE or a base station, as a consumer device, sends a third message to the NRF through the AMF; or the NF is a consumer device.

Step 4: The NRF or the UDM determines whether the AF (or NF) is in a sensing result exposure white list. Herein, the sensing result exposure white list is obtained based on first messages of all SFs. The NRF is used as an example. The NRF determines whether one or more SF entities exist, where the one or more SF entities can expose sensing data to the AF. For example, the NRF determines, based on the stored sensing service capability exposure information, whether the one or more SF entities that can expose the sensing data to the AF exist. If sensing service capability exposure information of the one or more SF entities matches AF information included in the network element query message and expected SF information, the NRF determines that the one or more SF entities can expose the sensing data to the AF. Otherwise, the NRF determines that no SF entity can expose the sensing data to the AF.

Corresponding to steps 3a1 and 3a2, in step 5a, the NRF or the UDM sends a fourth message or a fifth message, such as a network element discovery response message, to the AF. It is determined that the one or more SF entities can expose the sensing data to the AF, and the network element discovery response message includes a usage time/area scope (cope), and a usage purpose; otherwise, the network element discovery response message includes seventh information (cause code). Then, in step 6a, which is a sensing service procedure, the AF requests the matched SF to perform the sensing service to obtain required sensing service data. If the AF obtains information about the one or more SF entities, the AF may initiate a sensing service procedure (send a second message) to one of the SFs, or the AF may select an SF based on service logic of the AF to initiate an actual sensing service procedure (send a second message).

Corresponding to step 3b, in step 5b, the NRF or the UDM sends a fourth message or a fifth message, such as a network element discovery response message, to the NF (or AMF). It is determined that the one or more SF entities can expose the sensing data to the NF (or AMF), and the network element discovery response message includes a usage time/area cope, and a usage purpose; otherwise, the network element discovery response message includes seventh information (cause code). Then, in step 6b, which is a sensing service procedure, the NF (or AMF) requests the matched SF to perform the sensing service to obtain required sensing service data.

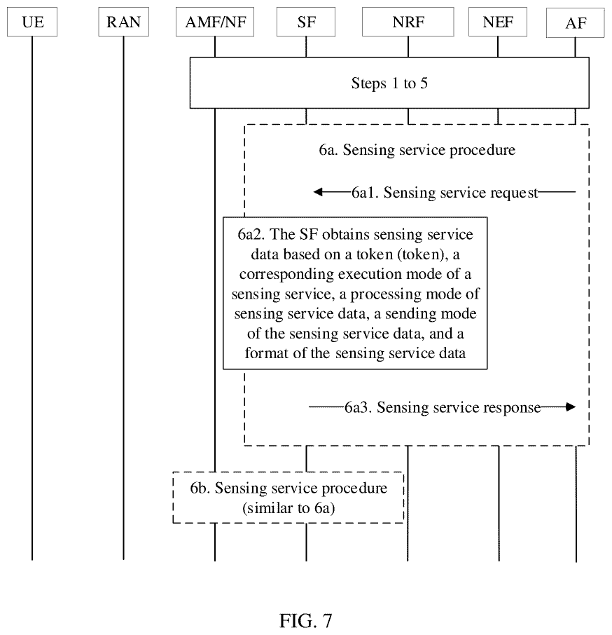

Scenario 2: An example in which a first device is an SF and a second device is an NRF is used for description. As shown in FIG. 7, the method includes the following steps.

Steps 1-5 in this scenario are the same as steps 1-5 in scenario 1. A difference lies in that in a sensing service procedure, a second message sent by a consumer device includes fifth information, such as token information (token) of the consumer device.

For sending a third message by an AF to the NRF:

Step 6a1: The AF (untrusted third-party service server) sends a second message, such as a sensing service request message (Sensing request), to a selected SF through a NEF, where the second message is used to trigger the sensing service procedure. The sensing request includes a token of the AF. The token of the AF may be obtained from a service agreement between the AF and an operator network, or obtained from a prior offline interconnection and debugging process between the SF and the AF. A purpose of the token of the AF is to negotiate and synchronize a processing mode of the sensing service and sensing data between the SF and the consumer device, but how to process and implement the foregoing is transparent or imperceptible to other devices, and is only known privately by the two parties.

Step 6a2: The SF obtains sensing service data based on the token of the AF, a corresponding execution mode of the sensing service, a processing mode of the sensing service data, a sending mode of the sensing service data, and a format of the sensing service data.

Step 6a3: The SF sends a fourth message or a fifth message, such as a sensing service response (Sensing result), to the AF. The sensing result includes a token and a container (sensing service data) of the AF.

For sending a third message by an AMF or an NF to the NRF, the sensing service procedure in step 6b is similar to that in step 6a. Details are not described herein again.

In conclusion, according to the methods in the embodiments of this application, the first device reports the sensing service capability exposure information of the first device to the unified second device, that is, an information storage and management network element, so that the second device knows an exposure scope, a usage scope, and a usage purpose of a sensing service capability of the first device based on the sensing service capability exposure information, and the second device controls access of the consumer device to the first device based on the information, thereby implementing effective permission management and access control.

It should be noted that the sensing service capability exposure methods performed by the first device, the second device, and the fourth device are implemented in cooperation, and the implementations of the foregoing method embodiments are applicable to each other. Details are not described again.

The sensing service capability exposure method provided in the embodiments of this application may be performed by a sensing service capability exposure apparatus. A sensing service capability exposure apparatus provided in the embodiments of this application is described by assuming that the sensing service capability exposure method in the embodiments of this application is performed by the sensing service capability exposure apparatus.

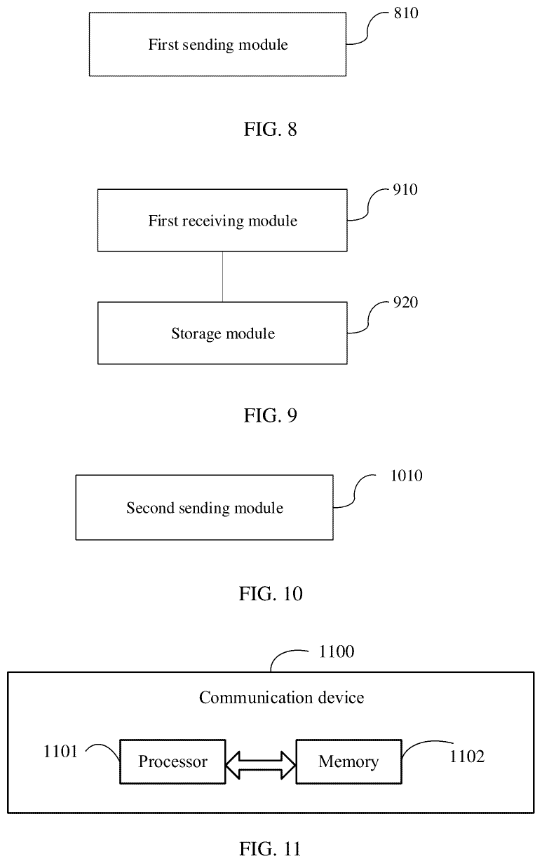

As shown in FIG. 8, a sensing service capability exposure apparatus according to an embodiment of this application includes:
a first sending module 810, configured to send a first message to a second device, where the first message includes sensing service capability exposure information of a first device.

Optionally, the sensing service capability exposure information includes at least one of the following:
first information, used to indicate an exposure scope of a sensing service;
second information, used to indicate a usage scope of the sensing service; or
third information, used to indicate a usage purpose of the sensing service.

Optionally, the first information includes at least one of the following:
identification information of a third device;
information about a consumer type or a device type to which the third device belongs;
vendor information of the third device;
token information of the third device;
public land mobile network PLMN information of the third device;
slice information corresponding to the third device; or
a data network name DNN corresponding to the third device, where
the third device is a device to which sensing service data of the first device is allowed to be exposed.

Optionally, the first message further includes at least one of the following:
identification information of the first device;
network element type information of the first device, where the network element type information is used to indicate that the first device is a network element supporting a sensing service control function; or
a name of a service supported by the first device, where the service includes a sensing capability exposure service.

Optionally, the sensing service capability exposure information corresponds to at least one piece of the following information:
identification information of the sensing service; or
fourth information, used to indicate a sensing scope of the sensing service.

Optionally, the first message further includes at least one of the following:
the identification information of the sensing service; or
the fourth information.

Optionally, the sensing scope of the sensing service includes at least one of the following: a sensing time scope; or a sensing area scope.

Optionally, the apparatus further includes:
a second receiving module, configured to receive a second message sent by a fourth device, where the second message is used to request a sensing service; and
a first processing module, configured to perform the sensing service based on the second message, and send obtained sensing service data to the fourth device.

Optionally, the second message includes at least one of the following:
a type of the requested sensing service;
identification information of the requested sensing service;
a usage purpose of the requested sensing service data;
a usage scope of the requested sensing service data;
identification information of the fourth device;
vendor information of the fourth device;
token information of the fourth device;
PLMN information of the fourth device;
slice information corresponding to the fourth device; or
a DNN corresponding to the fourth device.

Optionally, the second message includes fifth information, and the fifth information corresponds to at least one piece of the following information in the first device:
an execution mode of the sensing service;
a processing mode of the sensing service data;
a sending mode of the sensing service data; or
a format of the sensing service data.

Optionally, the sending mode includes sending the sensing service data in a container mode.

Optionally, the container mode includes at least one of the following:
a preset container mode; or
a container mode corresponding to a value of the fifth information.

Optionally, the first processing module is further configured to:
determine, based on the second message, whether the corresponding sensing service data is allowed to be exposed to the fourth device; and
in a case that the corresponding sensing service data is allowed to be exposed to the fourth device, perform the sensing service, and send the obtained sensing service data to the fourth device.

The apparatus notifies the sensing service capability exposure information of the apparatus to the second device, so that the second device stores the information. In this way, access of a consumer device to the first device can be controlled, and the sensing service data can be effectively accessed and used.

It should be noted that the apparatus applies the sensing service capability exposure method performed by the first device, and the implementations of the foregoing method embodiment are applicable to the apparatus, with the same technical effect achieved.

As shown in FIG. 9, a sensing service capability exposure apparatus according to an embodiment of this application includes:
a first receiving module 910, configured to receive a first message sent by a first device, where the first message includes sensing service capability exposure information of the first device; and
a storage module 920, configured to store the sensing service capability exposure information of the first device.

Optionally, the sensing service capability exposure information includes at least one of the following:
first information, used to indicate an exposure scope of a sensing service;
second information, used to indicate a usage scope of the sensing service; or
third information, used to indicate a usage purpose of the sensing service.

Optionally, the first information includes at least one of the following:
identification information of a third device;
information about a consumer type or a device type to which the third device belongs;
vendor information of the third device;
token information of the third device;
public land mobile network PLMN information of the third device;
slice information corresponding to the third device; or
a data network name DNN corresponding to the third device, where
the third device is a device to which sensing service data of the first device is allowed to be exposed.

Optionally, the apparatus further includes:
a third receiving module, configured to receive a third message sent by a fourth device, where the third message is used to request information about a fifth device, and the fifth device supports exposure of sensing service data to the fourth device; and
a second processing module, configured to determine, based on the third message and the stored sensing service capability exposure information of the first device, whether the fifth device exists.

Optionally, the third message includes at least one of the following:
a type of a requested sensing service;
identification information of the requested sensing service;
a usage purpose of requested sensing service data;
a usage scope of the requested sensing service data;
identification information of the fourth device;
vendor information of the fourth device;
token information of the fourth device;
PLMN information of the fourth device;
slice information corresponding to the fourth device; or
a DNN corresponding to the fourth device.

Optionally, the third message includes at least one of the following:
vendor information of the fifth device;
PLMN information of the fifth device;
slice information corresponding to the fifth device;
a DNN corresponding to the fifth device;
network element type information of the fifth device, where the network element type information is used to indicate that the fifth device is a network element supporting a sensing service control function; or
identification information of the fifth device.

Optionally, the second processing module is further configured to: determine whether the sensing service capability exposure information of the first device matches target information of the fourth device; and
in a case that the sensing service capability exposure information of the first device matches the target information of the fourth device, determine that the fifth device exists; or
in a case that the sensing service capability exposure information of the first device does not match the target information of the fourth device, determine that the fifth device does not exist, where
the target information includes at least one of the following:
vendor information;
token information;
a usage purpose of requested sensing service data; or
a usage scope of the requested sensing service data.

Optionally, the fifth device meets at least one of the following that:
vendor information of the fifth device matches vendor information of the fourth device;
token information of a device to which the sensing service data of the fifth device is allowed to be exposed matches the token information of the fourth device;
a usage purpose of the sensing service data of the fifth device matches a usage purpose of sensing service data requested by the fourth device; or
a usage scope of the sensing service data of the fifth device matches a usage scope of the sensing service data requested by the fourth device.

Optionally, the apparatus further includes:
a third sending module, configured to send a fourth message to the fourth device in a case that it is determined that the fifth device does not exist, where the fourth message includes at least one of the following:
sixth information, used to indicate that the fifth device does not exist; or
seventh information, used to indicate cause information for nonexistence of the fifth device, where
the cause information includes at least one of the following that: the fourth device is not a device corresponding to the sensing service capability exposure information of the first device; a usage purpose of requested sensing service data is not allowed by the first device; or a usage scope of the requested sensing service data does not match that of the sensing service capability exposure information of the first device.

Optionally, the apparatus further includes:
a fourth sending module, configured to send a fifth message to the fourth device in a case that it is determined that the fifth device exists, where the fifth message includes at least one of the following:
vendor information of the fifth device;
PLMN information of the fifth device;
slice information corresponding to the fifth device;
a DNN corresponding to the fifth device;
network element type information of the fifth device, where the network element type information is used to indicate that the fifth device is a network element supporting a sensing service control function;
identification information of the fifth device;
a usage purpose of the sensing service data of the fifth device;
a usage scope of the sensing service data of the fifth device; or
a sensing scope of a sensing service of the fifth device.

The apparatus receives the first message from the first device, and stores the sensing service capability exposure information of the first device, to prepare for subsequent control over access of a consumer device to the first device, so that the sensing service data can be effectively accessed and used.

It should be noted that the apparatus applies the sensing service capability exposure method performed by the second device, and the implementations of the foregoing method embodiment are applicable to the apparatus, with the same technical effect achieved.

As shown in FIG. 10, a sensing service capability exposure apparatus according to an embodiment of this application includes:
a second sending module 1010, configured to send a third message to a second device, where the third message is used to request information about a fifth device, and the fifth device supports exposure of sensing service data to a fourth device.

Optionally, the third message includes at least one of the following:
a type of a requested sensing service;
identification information of the requested sensing service;
a usage purpose of requested sensing service data;
a usage scope of the requested sensing service data;
identification information of the fourth device;
vendor information of the fourth device;
token information of the fourth device;
PLMN information of the fourth device;
slice information corresponding to the fourth device; or
a DNN corresponding to the fourth device.

Optionally, the third message includes at least one of the following:
vendor information of the fifth device;
PLMN information of the fifth device;
slice information corresponding to the fifth device;
a DNN corresponding to the fifth device;
network element type information of the fifth device, where the network element type information is used to indicate that the fifth device is a network element supporting a sensing service control function; or
identification information of the fifth device.

Optionally, the apparatus further includes:
a fourth receiving module, configured to receive a fourth message sent by the second device, where the fourth message includes at least one of the following:
sixth information, used to indicate that the fifth device does not exist; or
seventh information, used to indicate cause information for nonexistence of the fifth device, where
the cause information includes at least one of the following that: the fourth device is not a device corresponding to sensing service capability exposure information of a first device; a usage purpose of requested sensing service data is not allowed by the first device; or a usage scope of the requested sensing service data does not match that of the sensing service capability exposure information of the first device.

Optionally, the apparatus further includes:
a fifth receiving module, configured to receive a fifth message sent by the second device, where the fifth message includes at least one of the following:
vendor information of the fifth device;
PLMN information of the fifth device;
slice information corresponding to the fifth device;
a DNN corresponding to the fifth device;
network element type information of the fifth device, where the network element type information is used to indicate that the fifth device is a network element supporting a sensing service control function;
identification information of the fifth device;
a usage purpose of the sensing service data of the fifth device;
a usage scope of the sensing service data of the fifth device; or
a sensing scope of a sensing service of the fifth device.

Optionally, the apparatus further includes:
a fifth sending module, configured to send a second message to the fifth device, where the second message is used to request a sensing service; and
a sixth receiving module, configured to receive sensing service data sent by the fifth device.

Optionally, the second message includes at least one of the following:
a type of the requested sensing service;
identification information of the requested sensing service;
a usage purpose of requested sensing service data;
a usage scope of the requested sensing service data;
identification information of the fourth device;
vendor information of the fourth device;
token information of the fourth device;
PLMN information of the fourth device;
slice information corresponding to the fourth device; or
a DNN corresponding to the fourth device.

Optionally, the second message includes fifth information, and the fifth information corresponds to at least one piece of the following information in a first device:
an execution mode of the sensing service;
a processing mode of the sensing service data;
a sending mode of the sensing service data; or
a format of the sensing service data.

Optionally, the sending mode includes sending the sensing service data in a container mode.

Optionally, the container mode includes at least one of the following:
a preset container mode; or
a container mode corresponding to a value of the fifth information.

The apparatus sends the third message to the second device, so that the second device can respond to access of a consumer device to the first device for control and that the sensing service data can be effectively accessed and used.

It should be noted that the apparatus applies the sensing service capability exposure method performed by the fourth device, and the implementations of the foregoing method embodiment are applicable to the apparatus, with the same technical effect achieved.

The sensing service capability exposure apparatus in this embodiment of this application may be an electronic device, for example, an electronic device with an operating system, or may be a component in an electronic device, for example, an integrated circuit or a chip. The electronic device may be a terminal, or may be other devices than a terminal. For example, the terminal may include but is not limited to the foregoing illustrated type of the terminal 11. The other devices may be a server, a network attached storage (NAS), and the like. This is not limited in this embodiment of this application.

The sensing service capability exposure apparatus provided in this embodiment of this application can implement each process implemented in the method embodiments in FIG. 3 to FIG. 5, with the same technical effect achieved. To avoid repetition, details are not described herein again.

As shown in FIG. 11, an embodiment of this application further provides a communication device 1100, including a processor 1101 and a memory 1102. The memory 1102 stores a program or instructions executable on the processor 1101. For example, when the communication device 1100 is a terminal, and the program or instructions are executed by the processor 1101, the steps of the foregoing embodiment of the sensing service capability exposure method are implemented, with the same technical effect achieved. When the communication device 1100 is a network-side device, and the program or instructions are executed by the processor 1101, the steps of the foregoing embodiment of the sensing service capability exposure method are implemented, with the same technical effect achieved. To avoid repetition, details are not described herein again.

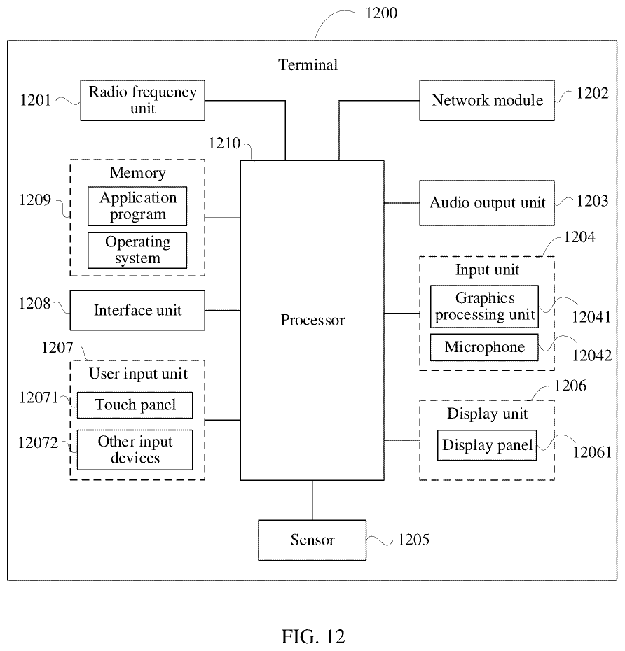

An embodiment of this application further provides a terminal, including a processor and a communication interface. The communication interface is coupled to the processor. The processor is configured to run a program or instructions to implement the steps in the method embodiment shown in FIG. 5. The terminal embodiment corresponds to the foregoing method embodiment on the fourth device side, and each implementation process and implementation of the foregoing method embodiment can be applied to the terminal embodiment, with the same technical effect achieved. Optionally, FIG. 12 is a schematic diagram of a hardware structure of a terminal for implementing an embodiment of this application.

The terminal 1200 includes but is not limited to at least some components such as a radio frequency unit 1201, a network module 1202, an audio output unit 1203, an input unit 1204, a sensor 1205, a display unit 1206, a user input unit 1207, an interface unit 1208, a memory 1209, and a processor 1210.

A person skilled in the art may understand that the terminal 1200 may further include a power supply (for example, a battery) supplying power to all components. The power supply may be logically connected to the processor 1210 through a power management system. In this way, functions such as charge management, discharge management, and power consumption management are implemented by using the power management system. The terminal structure shown in FIG. 12 does not constitute a limitation on the terminal. The terminal may include more or fewer components than those shown in the figure, or some components are combined, or component arrangements are different. Details are not described herein again.

It should be understood that, in this embodiment of this application, the input unit 1204 may include a graphics processing unit (GPU) 12041 and a microphone 12042. The graphics processing unit 12041 processes image data of a still picture or video obtained by an image capture apparatus (such as a camera) in a video capture mode or an image capture mode. The display unit 1206 may include a display panel 12061, and the display panel 12061 may be configured in a form of a liquid crystal display, an organic light-emitting diode, or the like. The user input unit 1207 includes at least one of a touch panel 12071 or other input devices 12072. The touch panel 12071 is also referred to as a touchscreen. The touch panel 12071 may include two parts: a touch detection apparatus and a touch controller. The other input devices 12072 may include but are not limited to a physical keyboard, a function button (such as a volume control button or a power button), a trackball, a mouse, and a joystick. Details are not described herein again.

In this embodiment of this application, after receiving downlink data from a network-side device, the radio frequency unit 1201 may transmit the downlink data to the processor 1210 for processing. In addition, the radio frequency unit 1201 may send uplink data to the network-side device. Usually, the radio frequency unit 1201 includes but is not limited to an antenna, an amplifier, a transceiver, a coupler, a low noise amplifier, a duplexer, and the like.

The memory 1209 may be configured to store software programs or instructions and various data. The memory 1209 may primarily include a first storage area for storing programs or instructions and a second storage area for storing data. The first storage area may store an operating system, an application program or instructions required by at least one function (such as an audio play function and an image play function), and the like. In addition, the memory 1209 may include a volatile memory or a non-volatile memory. The non-volatile memory may be a read-only memory (ROM), a programmable read-only memory (PROM), an erasable programmable read-only memory (EPROM), an electrically erasable programmable read-only memory (EEPROM), or a flash memory. The volatile memory may be a random access memory (RAM), a static random access memory (SRAM), a dynamic random access memory (DRAM), a synchronous dynamic random access memory (SDRAM), a double data rate synchronous dynamic random access memory (DDR SDRAM), an enhanced synchronous dynamic random access memory (ESDRAM), a synchlink dynamic random access memory (SLDRAM), and a direct rambus random access memory (DRRAM). The memory 1209 in this embodiment of this application includes but is not limited to these and any other suitable types of memories.

The processor 1210 may include one or more processing units. Optionally, the processor 1210 integrates an application processor and a modem processor. The application processor mainly processes operations related to the operating system, a user interface, an application program, and the like. The modem processor mainly processes a wireless communication signal. For example, the modem processor is a baseband processor. It may be understood that the modem processor may alternatively not be integrated in the processor 1210.

The radio frequency unit 1201 is configured to send a third message to a second device, where the third message is used to request information about a fifth device, and the fifth device supports exposure of sensing service data to a fourth device.

Optionally, the third message includes at least one of the following:
a type of a requested sensing service;
identification information of the requested sensing service;
a usage purpose of requested sensing service data;
a usage scope of the requested sensing service data;
identification information of the fourth device;
vendor information of the fourth device;
token information of the fourth device;
PLMN information of the fourth device;
slice information corresponding to the fourth device; or
a DNN corresponding to the fourth device.

Optionally, the third message includes at least one of the following:
vendor information of the fifth device;
PLMN information of the fifth device;
slice information corresponding to the fifth device;
a DNN corresponding to the fifth device;
network element type information of the fifth device, where the network element type information is used to indicate that the fifth device is a network element supporting a sensing service control function; or
identification information of the fifth device.

Optionally, the radio frequency unit is further configured to:
receive a fourth message sent by the second device, where the fourth message includes at least one of the following:
sixth information, used to indicate that the fifth device does not exist; or
seventh information, used to indicate cause information for nonexistence of the fifth device, where
the cause information includes at least one of the following that: the fourth device is not a device corresponding to sensing service capability exposure information of a first device; a usage purpose of requested sensing service data is not allowed by the first device; or a usage scope of the requested sensing service data does not match that of the sensing service capability exposure information of the first device.

Optionally, the radio frequency unit is further configured to:
receive a fifth message sent by the second device, where the fifth message includes at least one of the following:
vendor information of the fifth device;
PLMN information of the fifth device;
slice information corresponding to the fifth device;
a DNN corresponding to the fifth device;
network element type information of the fifth device, where the network element type information is used to indicate that the fifth device is a network element supporting a sensing service control function;
identification information of the fifth device;
a usage purpose of the sensing service data of the fifth device;
a usage scope of the sensing service data of the fifth device; or
a sensing scope of a sensing service of the fifth device.

Optionally, the radio frequency unit is further configured to:
send a second message to the fifth device, where the second message is used to request a sensing service; and
receive sensing service data sent by the fifth device.

Optionally, the second message includes at least one of the following:
a type of the requested sensing service;
identification information of the requested sensing service;
a usage purpose of requested sensing service data;
a usage scope of the requested sensing service data;
identification information of the fourth device;
vendor information of the fourth device;
token information of the fourth device;
PLMN information of the fourth device;
slice information corresponding to the fourth device; or
a DNN corresponding to the fourth device.

Optionally, the second message includes fifth information, and the fifth information corresponds to at least one piece of the following information in a first device:
an execution mode of the sensing service; a processing mode of the sensing service data; a sending mode of the sensing service data; or a format of the sensing service data.

Optionally, the sending mode includes sending the sensing service data in a container mode.

Optionally, the container mode includes at least one of the following:
a preset container mode; or a container mode corresponding to a value of the fifth information.

It may be understood that for the implementation process of each implementation in this embodiment, reference may be made to the related descriptions in the method embodiment, with the same or corresponding technical effect achieved. To avoid repetition, details are not described herein again.

An embodiment of this application further provides a network-side device, including a processor and a communication interface. The communication interface is coupled to the processor. The processor is configured to run a program or instructions to implement the steps in the method embodiment shown in FIG. 3 or FIG. 4 or FIG. 5. The network-side device embodiment corresponds to the foregoing method embodiment on the network-side device, and each implementation process and implementation of the foregoing method embodiment can be applied to the network-side device embodiment, with the same technical effect achieved.

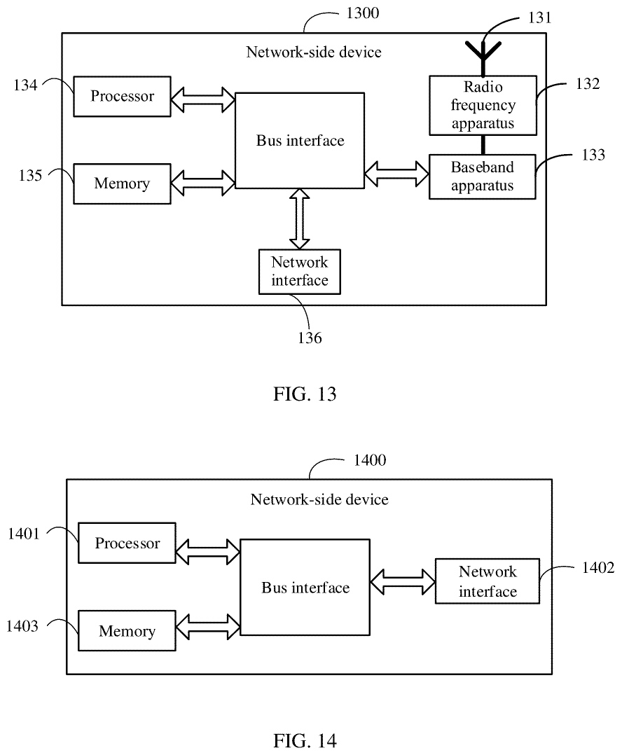

Optionally, an embodiment of this application further provides a network-side device. As shown in FIG. 13, the network-side device 1300 includes an antenna 131, a radio frequency apparatus 132, a baseband apparatus 133, a processor 134, and a memory 135. The antenna 131 is connected to the radio frequency apparatus 132. In an uplink direction, the radio frequency apparatus 132 receives information by using the antenna 131, and sends the received information to the baseband apparatus 133 for processing. In a downlink direction, the baseband apparatus 133 processes to-be-sent information, and sends the information to the radio frequency apparatus 132; and the radio frequency apparatus 132 processes the received information and then sends the information out by using the antenna 131.

The method performed by the network-side device in the foregoing embodiment may be implemented in the baseband apparatus 133. The baseband apparatus 133 includes a baseband processor.

The baseband apparatus 133 may include, for example, at least one baseband unit, where a plurality of chips are disposed on the baseband unit. As shown in FIG. 13, one of the chips is, for example, the baseband processor, connected to the memory 135 by using a bus interface, to invoke a program in the memory 135 to perform the operation of the network device shown in the foregoing method embodiment.

The network-side device may further include a network interface 136, where the interface is, for example, a common public radio interface (CPRI).

Optionally, the network-side device 1300 in this embodiment of this application further includes a program or instructions stored in the memory 135 and executable on the processor 134. When the processor 134 invokes the program or instructions in the memory 135, the method performed by each module shown in FIG. 10 is performed, with the same technical effect achieved. To avoid repetition, details are not described herein again.

Optionally, an embodiment of this application further provides a network-side device. As shown in FIG. 14, the network-side device 1400 includes a processor 1401, a network interface 1402, and a memory 1403. The network interface 1402 is, for example, a common public radio interface (CPRI).

Optionally, the network-side device 1400 in this embodiment of this application further includes a program or instructions stored in the memory 1403 and executable on the processor 1401. When the processor 1401 invokes the program or instructions in the memory 1403, the method performed by each module shown in FIG. 8 or FIG. 9 or FIG. 10 is performed, with the same technical effect achieved. To avoid repetition, details are not described herein again.

An embodiment of this application further provides a non-transitory readable storage medium. The non-transitory readable storage medium stores a program or instructions. When the program or instructions are executed by a processor, each process of the foregoing embodiment of the sensing service capability exposure method is implemented, with the same technical effect achieved. To avoid repetition, details are not described herein again.

The processor is a processor in the terminal in the foregoing embodiment. The non-transitory readable storage medium includes a non-transitory computer-readable storage medium, such as a computer read-only memory ROM, a random access memory RAM, a magnetic disk, or an optical disc.

In addition, an embodiment of this application provides a chip. The chip includes a processor and a communication interface. The communication interface is coupled to the processor. The processor is configured to run a program or instructions to implement each process of the foregoing embodiment of the sensing service capability exposure method, with the same technical effect achieved. To avoid repetition, details are not described herein again.

It should be understood that the chip provided in this embodiment of this application may also be referred to as a system-level chip, a system chip, a chip system, a system-on-chip, or the like.

In addition, an embodiment of this application provides a computer program or program product. The computer program or program product is stored in a non-transitory storage medium. The computer program or program product is executed by at least one processor to implement each process of the foregoing embodiment of the sensing service capability exposure method, with the same technical effect achieved. To avoid repetition, details are not described herein again.

An embodiment of this application further provides a sensing service capability exposure system, including a first device, a second device, and a fourth device. The first device may be configured to perform the steps of the foregoing sensing service capability exposure method performed by the first device. The second device may be configured to perform the steps of the foregoing sensing service capability exposure method performed by the second device. The fourth device may be configured to perform the steps of the foregoing sensing service capability exposure method performed by the fourth device.

It should be noted that in this specification, the term “comprise”, “include”, or any of their variants are intended to cover a non-exclusive inclusion, so that a process, a method, an article, or an apparatus that includes a list of elements not only includes those elements but also includes other elements that are not expressly listed, or further includes elements inherent to such process, method, article, or apparatus. In absence of more constraints, an element preceded by “includes a . . . ” does not preclude existence of other identical elements in the process, method, article, or apparatus that includes the element. In addition, it should be noted that the scope of the method and apparatus in the implementations of this application is not limited to performing the functions in an order shown or discussed, and may further include performing the functions in a substantially simultaneous manner or in a reverse order depending on the functions used. For example, the method described may be performed in an order different from that described, and various steps may be added, omitted, or combined. In addition, features described with reference to some examples may be combined in other examples.

Based on the foregoing descriptions of the implementations, a person skilled in the art may clearly understand that the foregoing embodiment methods can be implemented by using a computer software product in combination with a necessary general hardware platform, or by using hardware. The computer software product is stored in a storage medium (such as a ROM, a RAM, a magnetic disk, or an optical disc), and includes several instructions for instructing a terminal or a network-side device to perform the methods described in the embodiments of this application.

The foregoing describes the embodiments of this application with reference to the accompanying drawings. However, this application is not limited to the foregoing embodiments. The foregoing embodiments are merely illustrative rather than restrictive. Inspired by this application, a person of ordinary skill in the art may develop many other manners of embodiments without departing from principles of this application and the protection scope of the claims, and all such manners of embodiments fall within the protection scope of this application.

What is claimed is:

1. A sensing service capability exposure method, comprising:
sending, by a first device, a first message to a second device, wherein the first message comprises sensing service capability exposure information of the first device.

2. The method according to claim 1, wherein the sensing service capability exposure information comprises at least one of the following:
first information, used to indicate an exposure scope of a sensing service;
second information, used to indicate a usage scope of the sensing service; or
third information, used to indicate a usage purpose of the sensing service.

3. The method according to claim 2, wherein the first information comprises at least one of the following:
identification information of a third device;
information about a consumer type or a device type to which the third device belongs;
vendor information of the third device;
token information of the third device;
public land mobile network (PLMN) information of the third device;
slice information corresponding to the third device; or
a data network name (DNN) corresponding to the third device, wherein
the third device is a device to which sensing service data of the first device is allowed to be exposed.

4. The method according to claim 1, wherein the first message further comprises at least one of the following:
identification information of the first device;
network element type information of the first device, wherein the network element type information is used to indicate that the first device is a network element supporting a sensing service control function; or
a name of a service supported by the first device, wherein the service comprises a sensing capability exposure service.

5. The method according to claim 1, wherein the sensing service capability exposure information corresponds to at least one piece of the following information:
identification information of a sensing service; or
fourth information, used to indicate a sensing scope of the sensing service;
wherein the first message further comprises at least one of the following:
the identification information of the sensing service; or
the fourth information.

6. The method according to claim 5, wherein the sensing scope of the sensing service comprises at least one of the following: a sensing time scope; or a sensing area scope.

7. The method according to claim 1, further comprising:
receiving, by the first device, a second message sent by a fourth device, wherein the second message is used to request a sensing service; and
performing, by the first device, the sensing service based on the second message, and sending obtained sensing service data to the fourth device.

8. The method according to claim 7, wherein the second message comprises at least one of the following:
a type of the requested sensing service;
identification information of the requested sensing service;
a usage purpose of requested sensing service data;
a usage scope of the requested sensing service data;
identification information of the fourth device;
vendor information of the fourth device;
token information of the fourth device;
public land mobile network (PLMN) information of the fourth device;
slice information corresponding to the fourth device; or
a data network name (DNN) corresponding to the fourth device.

9. The method according to claim 7, wherein the second message comprises fifth information, and the fifth information corresponds to at least one piece of the following information in the first device:
an execution mode of the sensing service;
a processing mode of the sensing service data;
a sending mode of the sensing service data; or
a format of the sensing service data;
wherein the sending mode comprises sending the sensing service data in a container mode;
wherein the container mode comprises at least one of the following:
a preset container mode; or
a container mode corresponding to a value of the fifth information.

10. The method according to claim 7, wherein the performing, by the first device, the sensing service based on the second message, and sending obtained sensing service data to the fourth device comprises:
determining, by the first device based on the second message, whether a corresponding sensing service data is allowed to be exposed to the fourth device; and
in a case that the corresponding sensing service data is allowed to be exposed to the fourth device, performing, by the first device, the sensing service, and sending the obtained sensing service data to the fourth device.

11. A sensing service capability exposure method, comprising:
receiving, by a second device, a first message sent by a first device, wherein the first message comprises sensing service capability exposure information of the first device; and
storing, by the second device, the sensing service capability exposure information of the first device.

12. The method according to claim 11, wherein the sensing service capability exposure information comprises at least one of the following:
first information, used to indicate an exposure scope of a sensing service;
second information, used to indicate a usage scope of the sensing service; or
third information, used to indicate a usage purpose of the sensing service.

13. The method according to claim 12, wherein the first information comprises at least one of the following:
identification information of a third device;
information about a consumer type or a device type to which the third device belongs;
vendor information of the third device;
token information of the third device;
public land mobile network (PLMN) information of the third device;
slice information corresponding to the third device; or
a data network name (DNN) corresponding to the third device, wherein
the third device is a device to which sensing service data of the first device is allowed to be exposed.

14. The method according to claim 11, further comprising:
receiving, by the second device, a third message sent by a fourth device, wherein the third message is used to request information about a fifth device, and the fifth device supports exposure of sensing service data to the fourth device; and
determining, by the second device based on the third message and the stored sensing service capability exposure information of the first device, whether the fifth device exists.

15. The method according to claim 14, wherein the third message comprises at least one of the following:
a type of a requested sensing service;
identification information of the requested sensing service;
a usage purpose of requested sensing service data;
a usage scope of the requested sensing service data;
identification information of the fourth device;
vendor information of the fourth device;
token information of the fourth device;
public land mobile network (PLMN) information of the fourth device;
slice information corresponding to the fourth device; or
a data network name (DNN) corresponding to the fourth device.

16. The method according to claim 14, wherein the third message comprises at least one of the following:
vendor information of the fifth device;
public land mobile network (PLMN) information of the fifth device;
slice information corresponding to the fifth device;
a data network name (DNN) corresponding to the fifth device;
network element type information of the fifth device, wherein the network element type information is used to indicate that the fifth device is a network element supporting a sensing service control function; or
identification information of the fifth device.

17. The method according to claim 15, wherein the determining, by the second device based on the third message and the stored sensing service capability exposure information of the first device, whether the fifth device exists comprises:
determining whether the sensing service capability exposure information of the first device matches target information of the fourth device; and
in a case that the sensing service capability exposure information of the first device matches the target information of the fourth device, determining that the fifth device exists; or
in a case that the sensing service capability exposure information of the first device does not match the target information of the fourth device, determining that the fifth device does not exist, wherein
the target information comprises at least one of the following:
vendor information;
token information;
a usage purpose of requested sensing service data; or
a usage scope of the requested sensing service data.

18. The method according to claim 15, wherein the fifth device meets at least one of the following that:
vendor information of the fifth device matches vendor information of the fourth device;
token information of a device to which the sensing service data of the fifth device is allowed to be exposed matches the token information of the fourth device;
a usage purpose of the sensing service data of the fifth device matches a usage purpose of sensing service data requested by the fourth device; or
a usage scope of the sensing service data of the fifth device matches a usage scope of the sensing service data requested by the fourth device.

19. The method according to claim 14, further comprising:
in a case that it is determined that the fifth device does not exist, sending, by the second device, a fourth message to the fourth device, wherein the fourth message comprises at least one of the following:
sixth information, used to indicate that the fifth device does not exist; or
seventh information, used to indicate cause information for nonexistence of the fifth device, wherein
the cause information comprises at least one of the following that: the fourth device is not a device corresponding to the sensing service capability exposure information of the first device; a usage purpose of requested sensing service data is not allowed by the first device; or a usage scope of the requested sensing service data does not match that of the sensing service capability exposure information of the first device;
or,
in a case that it is determined that the fifth device exists, sending, by the second device, a fifth message to the fourth device, wherein the fifth message comprises at least one of the following:
vendor information of the fifth device;
public land mobile network (PLMN) information of the fifth device;
slice information corresponding to the fifth device;
a data network name (DNN) corresponding to the fifth device;
network element type information of the fifth device, wherein the network element type information is used to indicate that the fifth device is a network element supporting a sensing service control function;
identification information of the fifth device;
a usage purpose of the sensing service data of the fifth device;
a usage scope of the sensing service data of the fifth device; or
a sensing scope of a sensing service of the fifth device.

20. A first device, comprising a processor and a memory, wherein the memory stores a program or instructions executable on the processor, and the program or instructions, when executed by the processor, cause the first device to perform:
sending a first message to a second device, wherein the first message comprises sensing service capability exposure information of the first device.
